(19) United States
(12) Patent Application Publication
(10) Pub. No.: US 2025/0031616 A1
(43) Pub. Date: Jan. 30, 2025

(54) CONTROL DEVICE FOR CONTROLLING A SELF-PROPELLED COMBINE HARVESTER

(71) Applicant: CLAAS Selbstfahrende Erntemaschinen GmbH, Harsewinkel (DE)

(72) Inventors: Dennis Neitemeier, Lippetal (DE); Christian Füchtling, Rinkerode (DE); Sebastian Spiekermann, Ostbevern (DE); Daniel Irmer, Herzebrock-Clarholz (DE)

(73) Assignee: CLAAS Selbstfahrende Erntemaschinen GmbH, Harsewinkel (DE)

(21) Appl. No.: 18/786,900

(22) Filed: Jul. 29, 2024

(30) Foreign Application Priority Data
Jul. 27, 2023 (DE) 102023119957.9

(51) Int. Cl. A01D 41/127; A01D 41/02; A01D 41/14

(52) U.S. Cl. CPC A01D 41/1273; A01D 41/02; A01D 41/141; A01D 41/142

(57) ABSTRACT

A control device for controlling a self-propelled combine harvester. The combine harvester comprises a draper having a plurality of conveyor belts driven at a belt speed for collecting and conveying harvested material to a conveying device in the feed channel of the combine harvester, a plurality of working units arranged or positioned downstream from the feed channel for processing the picked-up harvested material, and a drive motor for driving the draper, the conveying device, the working units and a travel drive for operating the combine harvester at a driving speed which is regulated by the control device. The control device is configured to determine the utilization of the drive motor during harvesting mode and to automatically reduce the belt speed of the conveyor belts of the draper when a first limit value for a peak capacity of the drive motor saved in the control device is exceeded.

### CROSS REFERENCE TO RELATED APPLICATION

This application claims priority under 35 U.S.C. § 119 to German Patent Application No. DE 10 2023 119 957.9 filed Jul. 27, 2023, the entire disclosure of which is hereby incorporated by reference herein.

### TECHNICAL FIELD

The present invention relates to a control device for controlling a self-propelled combine harvester, and relates to a self-propelled combine harvester and a method for controlling a self-propelled combine harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 2 377 385 B1 discloses a method for detecting a harvested material jam forming on a working unit of a self-propelled combine harvester having a plurality of working units. The formation of the harvested material jam is determined by the evaluation of a parameter, which may serve to monitor the operating state of one of the working units of the combine harvester and may compare with a threshold value for this parameter (which may be characteristic of a harvested material jam forming on this working unit). The detection of an impending harvested material jam may lead to an activation of the working units upstream from the relevant working unit in order to reduce the supply of the volume of harvested material. As such a parameter, the rotational speed is monitored of the working unit at which the harvested material jam is forming. When a first threshold value for a drop in rotational speed is passed, at least one setting influencing the harvesting mode of the harvester may initially be changed, which may lead to a reduction in the volume of harvested material to be processed, while the settings of the working unit affected by the harvested material jam remain unchanged. This may give the working unit affected by a harvested material jam time to process the harvested material already in the working unit in order to avoid a jam. In support, the driving speed may also be reduced, which may decrease the picking up of harvested material.

US Patent Application Publication No. 2018/054964 A1, incorporated by reference in its entirety, discloses a combine harvester with a draper, where the belt speeds of the conveyor belts of the draper may be controlled by a control device depending on the driving speed of the combine harvester. The belt speeds may be reduced by a manual setting in order to react to locally-occurring lower crop densities in order to equalize the harvested material flow.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic and exemplary partial view of a combine harvester.

FIG. 2 illustrates a schematic and exemplary view of a draper.

FIG. 3 illustrates a schematic and exemplary simplified overview of the working units, drive motor and control device of the combine harvester.

FIG. 4 illustrates a schematic and exemplary representation of controlling the combine harvester by the control device.

### DETAILED DESCRIPTION

As discussed in the background, the driving speed of the combine harvester may be automatically controlled. For example, the combine harvester may be controlled depending on the throughput of the conveyor device in the feed channel. The harvested material throughput is determined with a time delay in relation to the point in time of picking up the harvested material up by the draper. This procedure for controlling the driving speed of the combine harvester may lead to a situation in which the control device reacts to an impending harvested material jam due to a suddenly increasing harvested material throughput, which may lead to a standstill of the combine harvester.

Thus, in one or some embodiments, a control device and a method for controlling a self-propelled combine harvester is disclosed for improved control behavior in the event of a suddenly increasing harvested material throughput. In one or some embodiments, this may be achieved by the disclosed control device, the disclosed self-propelled combine harvester, and the disclosed method for controlling a self-propelled combine harvester.

In one or some embodiments, a control device for controlling a self-propelled combine harvester is disclosed, with the combine harvester comprising a draper having one or more conveyor belts (such as a plurality of conveyor belts) driven at a belt speed for picking up and conveying harvested material to a conveying device in the feed channel of the combine harvester, one or more working units (such as a plurality of working units) downstream from the feed channel for processing the picked up harvested material, and a drive motor(s) configured to drive any one, any combination, or all of the draper, the conveyor device, the working units and a travel drive for operating the combine harvester at a driving speed, which may be regulated by the control device. In one or some embodiments, the control device is configured to automatically determine the utilization of the drive motor during harvesting mode and to automatically reduce the belt speed of the conveyor belts of the draper when a first limit value for a peak capacity of the drive motor, which is or may be stored in the control device (e.g., saved in a memory accessible (such as in communication with) a processor of the control device), is met or exceeded.

In one or some embodiments, in an operating situation in which a sudden increase in the harvested material throughput causes the combine harvester to approach the peak capacity of the drive motor, the belt speed of the conveyor belts may be reduced so that the volume flow that is fed to the combine harvester by the draper is reduced.

Such an operating situation may occur, for example, when the combine harvester passes through a depression in a field where, due to higher water availability, there may be a temporarily higher harvested material yield and therefore higher harvested material throughput than is the case before the depression.

In particular, a second limit value for the peak capacity of the drive motor, which is greater than the first limit value, may be saved or savable in the control device (e.g., saved in a memory accessible (such as in communication with) a processor of the control device). The second limit value may be used to take into account an operating situation in which the reduction of the belt speed of the conveyor belts of the draper alone may not be longer sufficient to compensate for the temporary additional load from the picked up harvested material.

Upon reaching or exceeding the second limit value, the control device may be configured to reduce the driving speed by activating the travel drive and to interrupt a given drivetrain of the draper and conveying device.

In one or some embodiments, the control device is configured to reduce the driving speed depending on the throughput upon reaching the first limit value. In this way, the reduced harvested material fed by the draper achieved by controlling the belt speed of the conveyor belts according to the invention may be supplemented by relieving the draper as such for the duration of the control.

In one or some embodiments, the control device may be configured to reduce the drive speed of the cutter bar and intake auger of the draper. This measure may contribute to a reduction in the utilization of the drive motor. This measure may also contribute to a reduction in the volume of harvested material fed to the working units downstream from the feed channel.

In one or some embodiments, the control device is configured to change the belt speed of the conveyor belts and/or the drive speed of the cutter bar and/or intake auger of the draper independently of each other by controlling one or more actuators (such as a plurality of actuators) for driving the conveyor belts, the cutter bar and the intake auger. For example, the control device may send one or more commands to the one or more actuators in order to change the belt speed of the conveyor belts and/or the drive speed of the cutter bar and/or intake auger of the draper independently of each other. This may make it possible to react more flexibly to fluctuations in the volume of harvested material picked up by the draper, such as when there is an increase and/or decrease in the volume of harvested material.

In particular, the control device may be configured to control or regulate the driving speed of the combine harvester depending on the throughput. This may enable operating the combine harvester essentially around the limit of the capacity of the drive motor in order to achieve the highest possible output of an operation.

In one or some embodiments, the control device may be configured to receive and evaluate one or more signals from a sensor arrangement (e.g., one or more sensors) arranged or positioned in the feed channel to determine the harvested material throughput.

Alternatively or additionally, the control device may be configured to receive and evaluate one or more signals that may be used by the control device to determine harvested material losses. The one or more signals may be generated by at least one loss sensor arrangement assigned (e.g., positioned in or on) to the combine harvester, and to control or regulate the driving speed of the combine harvester depending on the detected harvested material losses.

In one or some embodiments, the control device may be configured to operate the combine harvester in different, adjustable driving modes (such as a plurality of adjustable driving modes). The driving modes may comprise any one, any combination, or all of: a constant driving speed mode; a constant harvested material throughput mode; or a constant harvested material throughput at a specified loss level mode. In particular, one driving mode specifies a constant driving speed for which a target driving speed to be maintained is specified, another driving mode specifies a constant harvested material throughput for which a target harvested material throughput is specified in order to adjust the driving speed, or still another driving mode specifies a constant harvested material throughput at a specified loss level for which a target harvested material throughput and a target loss level to be maintained are specified in order to adjust the driving speed. In this regard, the control device may perform any one, any combination, or all of: for the constant driving speed mode, maintain the driving speed at the target driving speed specified; for the constant harvested material throughput mode, adjust the driving speed to maintain the harvested material throughput to be at the target harvested material throughput that is specified; and for the constant harvested material throughput at a specified loss level mode, adjust the driving speed to maintain: the harvested material throughput to be at the target harvested material throughput; and the loss level to be at the target loss level.

In one or some embodiments, a self-propelled combine harvester with a control device is disclosed, with the control device any one, some, or all features disclosed herein. In particular, the draper of the combine harvester may have any one, any combination, or all of a cutter bar; a plurality of driven conveyor belts; and an intake auger. The cutter bar and the intake auger may be mechanically driven, and the conveyor belts may be hydraulically driven. The provision of different drive types via a mechanical drivetrain and a hydraulic drivetrain may enable mutually independent control of the cutter bar and intake auger on the one hand and the driven conveyor belts on the other hand in order to be able to react more individually to fluctuations in the crop density and/or the driving speed.

Furthermore, the driven conveyor belts of the draper may be operated with belt speeds that may be set independently of one another (e.g., the control device may send one or more commands, such as to motors and/or actuators, in order to control the respective speed of one, some, or each of the conveyor belts of the draper independently of one another).

Furthermore, a method is disclosed that includes any one, some, or all of the features discussed herein. In particular, the method for controlling a self-propelled combine harvester may comprise using the combine harvester that includes a draper having one or more conveyor belts (e.g., a plurality of conveyor belts) driven at a belt speed for picking up and conveying harvested material to a conveying device in the feed channel of the combine harvester, one or more working units (such as a plurality of working units) downstream from the feed channel that are configured to process the harvested material that is picked up, and drive motor(s) by which any one, any combination, or all of the draper, the working units and a travel drive may be driven. In one or some embodiments, the control device may be configured to determine the utilization of the drive motor during harvesting mode, and the control device may control the belt speed (e.g., to reduce the belt speed) of the conveyor belts of the draper responsive to determining that a first limit value for a peak capacity of the drive motor (which is or may be saved in the control device) is exceeded.

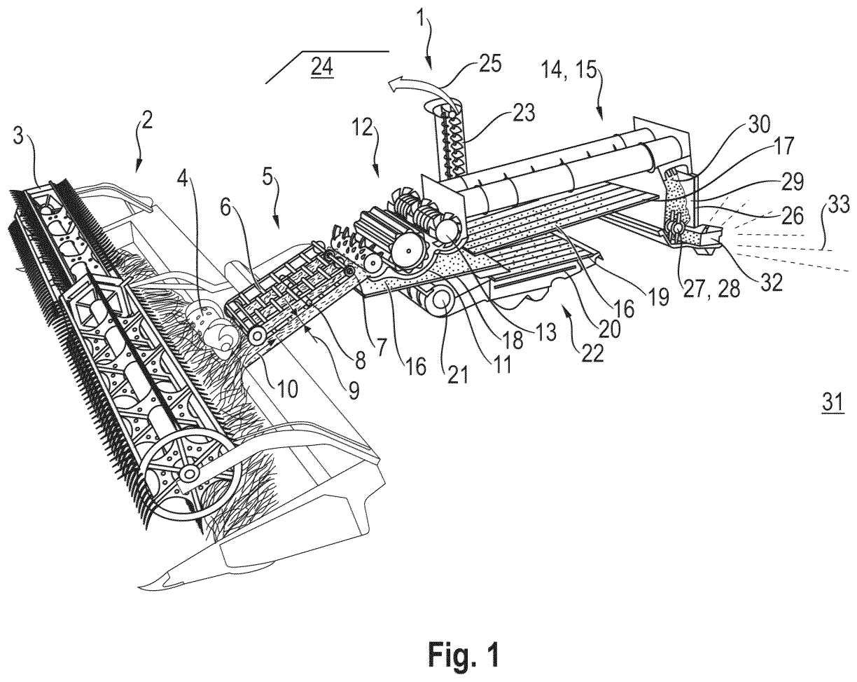

Referring to the figures, FIG. 1 shows a schematic partial view of a self-propelled combine harvester 1. Examples of combine harvesters are disclosed in US Patent Application Publication No. 20230397533 A1 and US Patent Application Publication No. 2024/0196796 A1, each of which is incorporated by reference herein in its entirety. In its front area, the combine harvester 1 accommodates an attachment designed as a draper 2, which may be connected in a manner known per se to a conveying device 5 arranged or positioned in the feed channel of the combine harvester 1. The draper 2 may have a reel 3 arranged or positioned on support arms and a intake auger 4 arranged or positioned in front of the conveying device 5.

Conveyor elements 6 of the conveying device 5 designed as an inclined conveyor may be pivotably guided at the top about a pivot axis 7 transverse to the longitudinal direction of the combine harvester 1. A sensor arrangement 8 may be arranged or positioned in the feed channel, which may provide one or more signals that may be used to determine the harvested material throughput. In one or some embodiments, a well-known layer height roller is assigned to the conveyor elements 6 in a central area as sensor arrangement 8. The deflection of the sensor arrangement 8, designed as a layer height roller, in the vertical direction may be a measure of a layer height 9 of a harvested material flow 10 passing through the conveying device 5.

In one or some embodiments, the harvested material flow 10 passing through the conveying device 5 may be transferred in the upper rear region of the conveying device 5 to the threshing units 12 of the combine harvester 1, which may at least partially be surrounded by a so-called threshing concave 11 on the bottom. A diverter roller 13 downstream from the threshing units 12 may divert the harvested material flow 10 out of the threshing units 12 in their rearward area so that the flow is transferred, such as immediately transferred, to a separating device 15 designed as a separating rotor assembly 14. In one or some embodiments, the separating device 15 may also be designed as a known, and therefore not shown, straw walker. An example of a straw walker is disclosed in US Patent Application Publication No. 2021/0360852 A1, incorporated by reference herein in its entirety. It is also within the scope of the invention that the separating rotor assembly 14 is designed only with one separating rotor, or the threshing units 12 and the separating device 15 are combined to form a single-or double-rotor axial flow threshing and separating device.

In the separating device 15, the harvested material flow 10 may be conveyed in such a way that free-moving grains 16 contained in the harvested material flow 10 are separated in the downstream region of the separating device 15. The grains 16 deposited both on the threshing concave 11 as well as in the separating device 15 may be fed over a returns pan 17 and a feed pan 18 of a cleaning device 22 comprising (or consisting of) a plurality of screening levels 19, 20 and a blower 21. The cleaned flow of grains 25 may then be transferred using an elevator 23 to a grain tank 24.

In the rear region of the separating device 15, a shredding device 28, designed as a straw chopper 27 and surrounded by a funnel-shaped housing 26, may be associated with the separating device 15. The straw 30 leaving the separating device 15 in the rear region may be fed to the straw chopper 27 at the top. Using a pivotable straw guide flap 29, the straw 30 may also be deflected in such a way that it is deposited directly on the ground 31 in a swath.

In the outlet area of the straw chopper 27, the stream of material comprising (or consisting of) the chopped straw 30 and the non-grain constituents separated in the cleaning device 22 may be transferred to a material distribution device 32. The material distribution device 32 may discharge a residual material stream 33 comprising (or consisting of) essentially of the straw 30 and the non-grain constituents in such a way that the residual material stream 33 is broadly distributed on the ground 31.

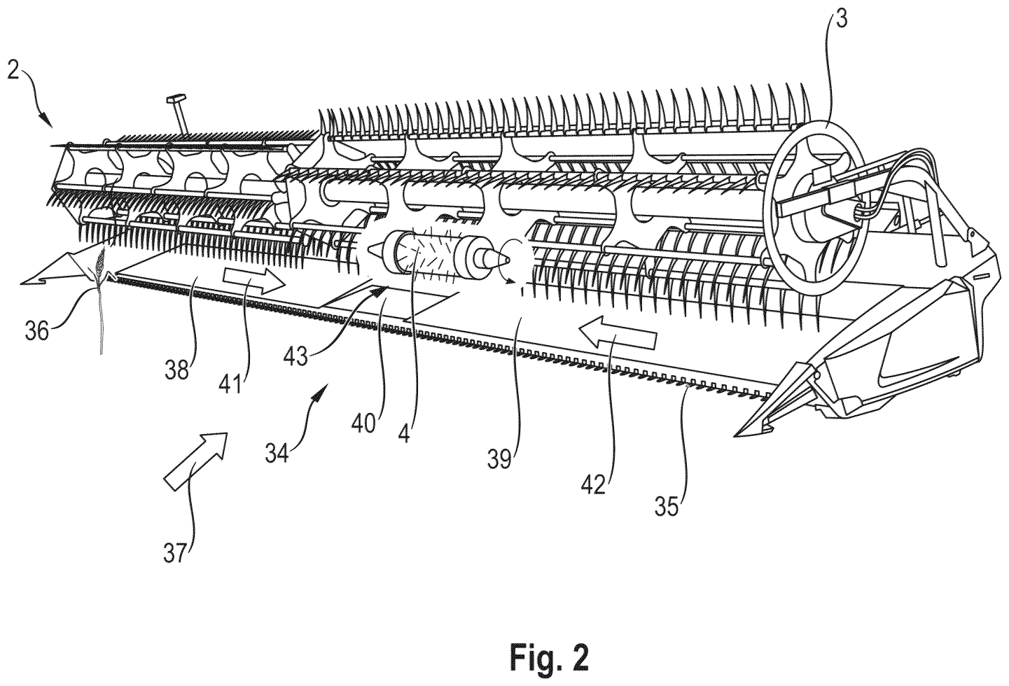

FIG. 2 illustrates a schematic and exemplary view of the draper 2. In the area 34 facing the crop 36 on the input side, the draper 3 has a cutter bar 35, which may cut off the crop 36 to be harvested. The cutter bar 35 may be either rigid or flexible. It is also contemplated that the flexible cutter bar 35 may be operated rigidly. A flexibly designed cutter bar 35 may better follow changes in the ground contour in the longitudinal and transverse direction in a known manner. In the illustrated embodiment, at least one, some, or all of left-sided conveyor belt 38, at least one right-sided conveyor belt 39 and a central conveyor belt 40 may be arranged or positioned downstream from the cutter bar 35 as seen in the feed direction 37 of the harvested crop 36. The left-sided conveyor belt 38 may convey the harvested crop 36 it has collected in the direction of arrow 41 towards the central conveyor belt 40 and may transfer it to the latter. Similarly, the right side conveyor belt 39 may convey the harvested crop 36 that it has collected in the direction of arrow 42 in the direction of the central conveyor belt 40, and may transfer it thereto. The central conveyor belt 40 then may convey the crop 36 which it has collected and which has been transferred to the conveyor belt 40 by the conveyor belts 38, 39 into the rear region of the draper 2 in the direction of the arrow 43. In this rear area, the crop 36 may be collected by the rotating intake auger 4 (e.g., a feed roller) assigned to this area and may be transferred as the aforementioned harvested material flow 10 to the conveying device 5 in the feed channel of the combine harvester 1.

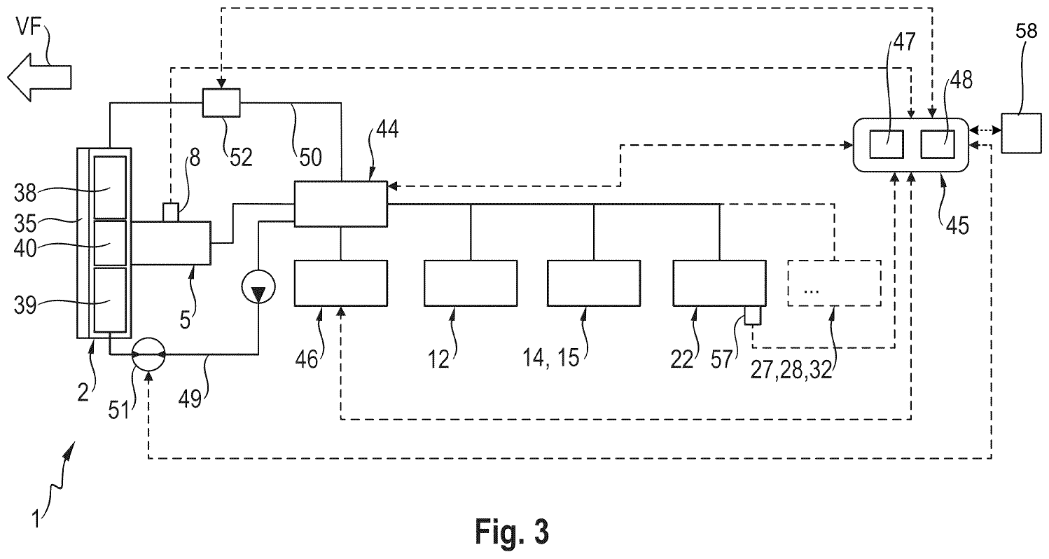

FIG. 3 shows a schematic and exemplary simplified overview of the working units, a drive motor 44 and a control device 45 for the combine harvester 1. In one or some embodiments, the self-propelled combine harvester 1 is controlled using the control device 45. The control device 45 comprises at least one memory unit (e.g., a memory unit 47) and at least one computing unit (e.g., a computing unit 48), which may be in communication with one another. In one or some embodiments, the computing unit 48 may comprise a microprocessor, controller, PLA, or the like. Similarly, the memory unit 47 may comprise any type of storage device (e.g., any type of memory). Though the computing unit 48 and the memory unit 47 are depicted as separate elements, they may be part of a single machine, which includes a microprocessor (or other type of controller) and a memory. Alternatively, the computing unit 48 may rely on the memory unit 47 for all of its memory needs. The memory unit 47 may comprise a tangible computer-readable medium that include software that, when executed by the computing unit 48 is configured to perform any one, any combination, or all of the functionality described herein regarding any computing device.

The computing unit 48 and the memory unit 47 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, the drive motor 44 is designed as an internal combustion engine. In addition to the draper 2, the conveying device 5 in the feed channel and the working units downstream from the conveying device 5, the drive motor 44 drives a travel drive, such as a hydrostatic travel drive 46, of the combine harvester 1 in order to move it over the ground 31 at a regulatable or adjustable driving speed VF during the harvesting process.

In one or some embodiments, the conveyor belts 38, 39, 40 of the draper 2 are driven (e.g., hydraulically driven). For this purpose, the conveyor belts 38, 39, 40 may be connected to drivetrain, such as a hydraulic drivetrain 49. The conveyor belts 38, 39, 40 may each have a controllable or regulatable actuator 51, which may be designed as a hydraulic motor. The control device 45 may control the individual actuators 51 of the conveyor belts 38, 39, 40 (e.g., the control device 45 may send commands to control the individual actuators 51 of the conveyor belts 38, 39, 40). The conveyor belts 38, 39, 40 may be driven at a belt speed VL for the left-sided conveyor belt 38, at a belt speed VM for the central conveyor belt 40, and at a belt speed VR for the right-sided conveyor belt 39. The belt speeds VL, VM and VR may be adjusted independently of one another by the control device 45 individually controlling the actuators 51.

In one or some embodiments, the cutter bar 35, the reel 3 and the intake auger 4 are driven mechanically, independently of the conveyor belts 38, 39, 40. For this purpose, the cutter bar 35, the reel 3 and the intake auger 4 may be connected to the drive motor 44 by a mechanical drivetrain 50. In one or some embodiments, the mechanical drivetrain 50 may comprise a gearbox as a controllable or regulatable actuator 52. The actuator 52 may be controlled by the control device 45.

In one or some embodiments, the control device 45 controls one or more devices wired and/or wirelessly. For example, in one or some embodiments, the control device 45 is connected by one or more signal lines to the drive motor 44, the travel drive 46 and the controllable actuators 51 of the hydraulic drivetrain 49 and the actuator 52 of the mechanical drivetrain 50 for receiving operating parameters and for transmitting control commands. The control device 45 may also be connected by a signal line to the sensor arrangement 8 arranged or positioned in the feed channel for determining the harvested material throughput. In this way, the control device 45 may receive one or more signals generated by the sensor arrangement 8. The control device 45 may be configured to evaluate (such as continuously evaluate) signal(s) generated by the sensor arrangement 8 relating to the layer height 9 in the feed channel. For example, the sensor arrangement 8 may generate the signal(s), which may be indicative of and/or used for evaluating the layer height 9 in the feed channel. In this way, the control device 45 may determine, based on evaluating or analyzing the signal(s) from the sensor arrangement 8, the layer height 9 in the feed channel.

In one or some embodiments, the control device 45 is configured to operate the self-propelled combine harvester 1 in a plurality of different driving modes. In one or some embodiments, the different driving modes are adjustable. A constant driving speed VF may be specified as one driving mode in which a target driving speed is specified. An alternative driving mode may specify a constant harvested material throughput, in which a target harvested material throughput is specified in order to adjust the driving speed VF depending on the target harvested material throughput. Another driving mode may specify a constant harvested material throughput with a specified loss level, in which a target harvested material throughput and a target loss level to be maintained may be specified in order to adjust the driving speed VF depending on the target harvested material throughput and the target loss level to be maintained.

For the execution of the driving mode, which may be based on a constant harvested material throughput at a predetermined loss level, the control device 45 may be configured to receive and evaluate signals for determining harvested material losses from at least one loss sensor arrangement 57 assigned to the combine harvester 1 in order to control or regulate the driving speed VF of the combine harvester 1 depending on the harvested material losses detected using the at least one loss sensor arrangement 57 and the harvested material throughput detected using the sensor arrangement 8. For this purpose, the at least one loss sensor arrangement 57 may be arranged or positioned downstream from the cleaning device 22.

In one or some embodiments, the different driving modes are saved or may be saved in the memory unit 47 of the control device 45. The various parameters of the driving modes may be specified and changed via a user interface 58 (such as a touchscreen).

The control device 45 may be configured to determine the utilization of the drive motor 44 during harvesting mode and to reduce the belt speed of the conveyor belts 38, 39, 40 of the draper 2 when a first limit value 55 for a peak capacity of the drive motor 44, which is or may be saved in the control device 45, is exceeded. In this regard, the control device 45 may: automatically determine utilization of the drive motor during harvesting mode; automatically determine whether the utilization of the drive motor meets or exceeds the first limit value for the peak capacity of the drive motor; and responsive to determining that the utilization of the drive motor meets or exceeds the first limit value for the peak capacity of the drive motor, automatically reduce the belt speed of one or more of the conveyor belts of the draper.

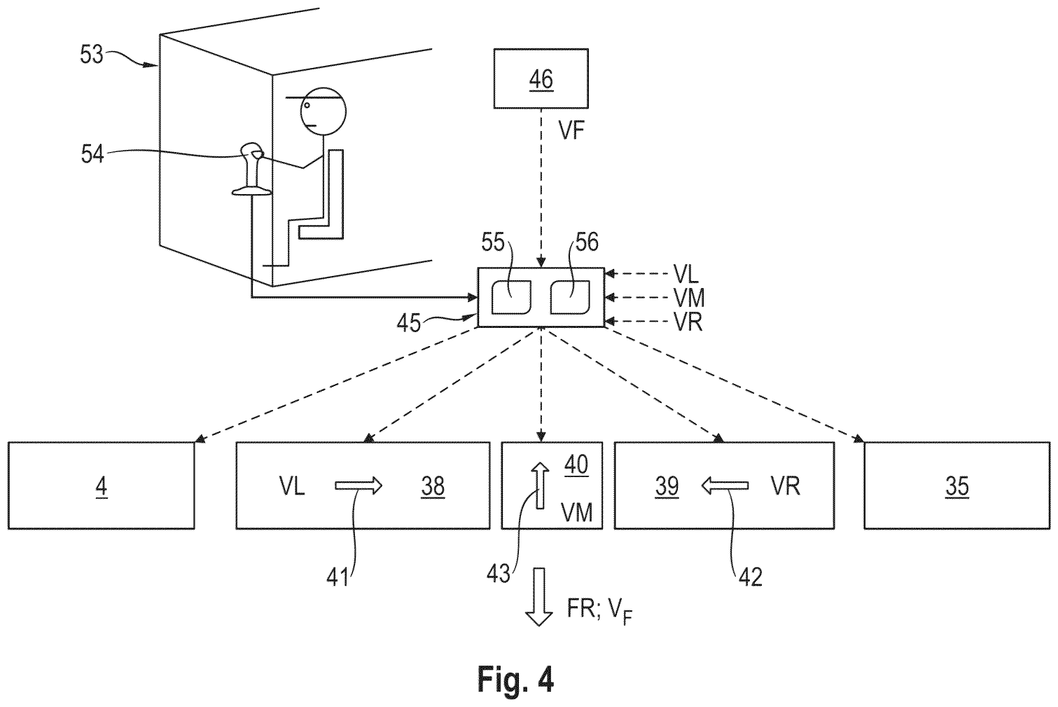

FIG. 4 shows a schematic representation of controlling the combine harvester 1 by the control device 45. At least one control element 54 (e.g., a joystick with one or more buttons, lever with one or more buttons, control handle with one or more buttons, or the like) may be located in a cab 53 of the combine harvester 1, with which the driving speed VF or one of the travel modes saved in the memory unit 47 may be selected and/or adjusted in order to control the travel drive 46 in accordance with the selected travel mode. FR indicates the direction of travel when the combine harvester 1 enters the crop 36 in order to harvest it.

Responsive to the control device 45, based on comparing the utilization of the drive motor 44 with the first limit value 55, determining that the utilization of the drive motor 44 meets or exceeds the first limit value 55, the control device 45 may determine an operating situation in which a sudden increase in the harvested material throughput leads to the combine harvester 1 approaching the peak capacity of the drive motor 44. In response to the control device 45 making this determination, the control device may send one or more commands in order to reduce the belt speed VL, VR, VM of any one, any combination, or all of the conveyor belts 38, 39, 40 so that the volume flow with harvested material already picked up, which is fed to the combine harvester 1 by the draper 2, may be reduced.

The control device 45 may have access to a second limit value 56 for the peak capacity of the drive motor 44, which is greater than the first limit value 55, and which may be saved in the memory unit 47 of the control device 45. The second limit value 56 may be used to take into account an operating situation in which the reduction of the belt speeds VL, VR, VM of the conveyor belts 38, 39, 40 alone is no longer sufficient to compensate for the temporary additional load caused by the picked up harvested material during conveying and processing by the working units of the combine harvester 1.

In particular, the control device 45 may compare the utilization of the drive motor 44 with the second limit value 56. Responsive to the control device determining that the utilization of the drive motor 44 meets or exceeds the second limit value 56, the control device 45 may be configured to: reduce the driving speed VF by controlling the travel drive 46; and/or interrupt the hydraulic drivetrain 49 of the draper 2 and/or the drivetrain of the conveying device 5.

Alternatively, or in addition, the control device 45 is configured to reduce the driving speed VF depending on the throughput upon reaching the first limit value 55. This may counteract unwanted accumulation of the picked up harvested material in the draper 2.

Furthermore, the control device 45 may be configured to reduce the drive speed of the cutter bar 35 and/or intake auger 4 of the draper 2. For this purpose, the control device 45 may control the actuators 52 in the mechanical drivetrain 50 of the draper 2.

In this regard, the control device 45 may be configured to perform any one, any combination, or all of: control (such as reduce) the belt speed VL, VR, VM of any one, any combination, or all of the conveyor belts 38, 39, 40; control (such as reduce) the driving speed VF of the combine harvester 1; control (such as reduce) the drive speed of the cutter bar 35; or control (such as reduce) the drive speed of the intake auger 4. Further, the control device 45 may control different aspects of the combine harvester 1 based on a same metric. For example, the control device 45 may control the belt speed VL, VR, VM and the drive speed VF of the combine harvester based on the utilization of the drive motor 44. The control of the different parts (e.g., the belt speed VL, VR, VM and the drive speed VF) may be based on comparing the utilization of the drive motor 44 with different limit values (e.g., the first limit value 55 and the second limit value 56).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Combine harvester 34 Input side area of 2
2 Draper 35 Cutter bar
3 Reel 36 Crop
4 Intake auger 37 Feed direction
Conveying device 38 Conveyor belt
6 Conveying unit 39 Conveyor belt
7 Pivot axle 40 Conveyor belt
8 Sensor assembly 41 Arrow direction
9 Layer height 42 Arrow direction
Harvested material flow 43 Arrow direction
11 Threshing concave 44 Drive motor
12 Threshing unit 45 Control device
13 Deflection drum 46 Drive
14 Separating rotor assembly 47 Memory unit
Separating device 48 Computing unit
16 Grains 49 Drivetrain
17 Returns pan 50 Drivetrain
18 Feed floor 51 Actuator
19 Screening level 52 Actuator
Screening level 53 Cab
21 Fan 54 Operating element
22 Cleaning device 55 First limit value
23 Elevator 56 Second limit value
24 Grain tank 57 Loss sensor arrangement
Grain flow 58 User interface
26 housing FR Driving direction
27 Straw chopper VF Driving speed
28 Shredding device VL Belt speed
29 Separating rotor assembly V Belt speed
30 Straw VR Belt speed
31 Ground M
32 Crop distribution device
33 Residual material flow

1. A control device configured to control a self-propelled combine harvester that includes a draper having a plurality of conveyor belts driven at a belt speed for picking up and conveying harvested material to a conveying device in a feed channel of the combine harvester, one or more working units positioned downstream from the feed channel and configured to process the harvested material that is picked-up, and a drive motor configured to drive the draper, the conveying device, the one or more working units and a travel drive configured to operate the combine harvester at a driving speed, the control device comprising:
at least one memory configured to store a first limit value for a peak capacity of the drive motor; and
at least one processor in communication with the memory, the at least one processor configured to:
automatically determine utilization of the drive motor during harvesting mode;
automatically determine whether the utilization of the drive motor meets or exceeds the first limit value for the peak capacity of the drive motor; and
responsive to determining that the utilization of the drive motor meets or exceeds the first limit value for the peak capacity of the drive motor, automatically reduce the belt speed of one or more of the conveyor belts of the draper.

2. The control device of claim 1, wherein the at least one memory is further configured to store a second limit value for the peak capacity of the drive motor; and
wherein the second limit value is greater than the first limit value.

3. The control device of claim 2, wherein the at least one processor is further configured to:
automatically determine whether the utilization of the drive motor meets or exceeds the second limit value for the peak capacity of the drive motor; and
responsive to determining that the utilization of the drive motor meets or exceeds the second limit value for the peak capacity of the drive motor, automatically reduce the driving speed by activating the travel drive and automatically interrupt a respective drivetrain of the draper and conveying device.

4. The control device of claim 1, wherein the control device is further configured to:
determine a throughput of the conveying device; and
responsive to determining that the utilization of the drive motor meets or exceeds the first limit value for the peak capacity of the drive motor, automatically reduce the driving speed depending on the throughput of the conveying device.

5. The control device of claim 4, wherein the control device is configured to receive one or more signals from a sensor arrangement positioned in the feed channel; and
wherein the at least one processor is configured to determine the throughput of the conveying device by evaluating the one or more signals from the sensor arrangement.

6. The control device of claim 1, wherein the at least one processor, responsive to determining that the utilization of the drive motor meets or exceeds the first limit value for the peak capacity of the drive motor, is further configured to automatically reduce drive speed of a cutter bar and intake auger of the draper.

7. The control device of claim 6, wherein the control device is configured to change the belt speed of the conveyor belts and the drive speed of the cutter bar and intake auger of the draper independently of one another by controlling one or more actuators configured to drive the conveyor belts, the cutter bar and the intake auger.

8. The control device of claim 1, wherein the at least one processor is further configured to:
determine a throughput of the conveying device; and
control or regulate the driving speed of the combine harvester depending on the throughput of the conveying device.

9. The control device of claim 1, wherein the control device is configured to receive one or more signals from at least one loss sensor arrangement positioned on the combine harvester; and
wherein the at least one processor is further configured to:
determine, based on the one or more signals from the at least one loss sensor arrangement, harvested material losses; and
control the driving speed of the combine harvester depending on the harvested material losses.

10. The control device of claim 1, wherein the control device is configured to operate the combine harvester in a plurality of different adjustable driving modes;
wherein the plurality of different adjustable driving modes comprise one or more of:
a constant driving speed mode for which a target driving speed to be maintained is specified;
a constant harvested material throughput mode for which a target harvested material throughput is specified;
a constant harvested material throughput at a specified loss level mode whereby the target harvested material throughput and a target loss level to be maintained are specified; and
wherein the at least one processor is configured to perform one or more of:
for the constant driving speed mode, maintain the driving speed at the target driving speed specified;
for the constant harvested material throughput mode, adjust the driving speed to maintain the harvested material throughput to be at the target harvested material throughput that is specified; and
for the constant harvested material throughput at a specified loss level mode, adjust the driving speed to maintain: the harvested material throughput to be at the target harvested material throughput; and the loss level to be at the target loss level.

11. The control device of claim 1, wherein the control device is configured to operate the combine harvester in a plurality of different adjustable driving modes;
wherein the plurality of different adjustable driving modes comprise:
a constant driving speed mode for which a target driving speed to be maintained is specified;
a constant harvested material throughput mode for which a target harvested material throughput is specified;
a constant harvested material throughput at a specified loss level mode whereby the target harvested material throughput and a target loss level to be maintained are specified; and
wherein the at least one processor is configured to perform:
for the constant driving speed mode, maintain the driving speed at the target driving speed specified;
for the constant harvested material throughput mode, adjust the driving speed to maintain the harvested material throughput to be at the target harvested material throughput that is specified; and
for the constant harvested material throughput at a specified loss level mode, adjust the driving speed to maintain: the harvested material throughput to be at the target harvested material throughput; and the loss level to be at the target loss level.

12. A self-propelled combine harvester comprising:
a draper including a plurality of conveyor belts configured to be driven at a belt speed for picking up and conveying harvested material to a conveying device in a feed channel of the combine harvester;
one or more working units positioned downstream from the feed channel and configured to process the harvested material;
at least one drive motor configured to drive the draper; and
a control device configured to:
regulate a driving speed of the combine harvester;
automatically determine utilization of the drive motor during harvesting mode;
automatically determine, based on the utilization of the drive motor, whether a first limit value for a peak capacity of the drive motor is met or exceeded;
responsive to determining that the first limit value for the peak capacity of the drive motor is met or exceeded, automatically reduce the belt speed of one or more of the conveyor belts of the draper.

13. The self-propelled combine harvester of claim 12, wherein the draper has a cutter bar, the plurality of conveyor belts and an intake auger;
wherein the cutter bar and the intake auger are mechanically driven;
wherein the plurality of conveyor belts are hydraulically driven;
wherein the control device is configured to mechanically control the cutter bar and the intake auger; and
wherein the control device is configured to hydraulically control the plurality of conveyor belts.

14. The self-propelled combine harvester of claim 12, wherein the control device is configured to control operation of belt speeds of the one or more of the plurality of conveyor belts of the draper so that the belt speeds are independently set of one another.

15. The self-propelled combine harvester of claim 12, wherein the control device is further configured to:
automatically determine whether the utilization of the drive motor meets or exceeds a second limit value for the peak capacity of the drive motor, the second limit value being greater than the first limit value; and
responsive to determining that the utilization of the drive motor meets or exceeds the second limit value for the peak capacity of the drive motor, automatically reduce the driving speed by activating a travel drive and automatically interrupt a respective drivetrain of the draper and conveying device.

16. The self-propelled combine harvester of claim 12, wherein the control device is further configured to:
determine a throughput of the conveying device; and
responsive to determining that the utilization of the drive motor meets or exceeds the first limit value for the peak capacity of the drive motor, automatically reduce the driving speed depending on the throughput of the conveying device.

17. The self-propelled combine harvester of claim 12, wherein the control device, responsive to determining that the utilization of the drive motor meets or exceeds the first limit value for the peak capacity of the drive motor, is further configured to automatically reduce drive speed of a cutter bar and intake auger of the draper.

18. A method for controlling a self-propelled combine harvester, the method comprising:
using the combine harvester, the combine harvester comprising a draper having a plurality of conveyor belts driven at a belt speed for picking up and conveying harvested material to a conveying device in a feed channel of the combine harvester, one or more working units positioned downstream from the feed channel for processing the harvested material that is collected, and a drive motor with which the draper, the one or more working units and a travel drive are driven;
automatically determining, by a control device of the combine harvester, a utilization of the drive motor during harvesting mode;
automatically determining, based on the utilization of the drive motor, whether a first limit value for the peak capacity of the drive motor is met or exceeded; and
responsive to determining that the first limit value for the peak capacity of the drive motor is met or exceeded, automatically reducing the belt speed of the conveyor belts of the draper.

19. The method of claim 18, further comprising:
automatically determining whether the utilization of the drive motor meets or exceeds a second limit value for the peak capacity of the drive motor, the second limit value being greater than the first limit value; and
responsive to determining that the utilization of the drive motor meets or exceeds the second limit value for the peak capacity of the drive motor, automatically reducing driving speed of the combine harvester by activating the travel drive and automatically interrupting a respective drivetrain of the draper and the conveying device.

20. The method of claim 18, further comprising:
determining a throughput of the conveying device; and
responsive to determining that the utilization of the drive motor meets or exceeds the first limit value for the peak capacity of the drive motor, automatically reducing driving speed of the combine harvester depending on the throughput of the conveying device.
